(19) United States
(12) Patent Application Publication
(10) Pub. No.: US 2009/0188417 A1
(43) Pub. Date: Jul. 30, 2009

(54) ANCHOR REELING

(76) Inventor: Bruce K. VanScoyoc, Evart, MI (US)

Correspondence Address: Timothy S. Stevens, Patent Attorney, 5108 Foxpoint Circle, Midland, MI, 48642, US

(21) Appl. No.: 12/321,961

(22) Filed: Jan. 27, 2009

Related U.S. Application Data
(60) Provisional application No. 61/062,617, filed on Jan. 28, 2008.

(51) Int. Cl. B63B 21/16; B63B 21/22; B66D 1/72

(52) U.S. Cl. 114/210

(57) ABSTRACT

A new use for a cranked reel employing a clutch bearing and a drag, which drag is controllably released by reverse rotation of the crank. The new use is to raise or lower an anchor using a cranked reel employing a clutch bearing and a drag, which drag is controllably released by reverse rotation of the crank.

This application claims priority to U.S. Provisional Patent Application Ser. No. 61/062,617 filed Jan. 28, 2008.

### BACKGROUND OF THE INVENTION

The instant invention relates to reeling systems and more specifically to a new use for a cranked reel employing a clutch bearing and a drag, which drag is controllably released by reverse rotation of the crank.

Hand cranked reeling systems employing a clutch bearing and a drag, which drag is controllably released by reverse rotation of the crank are known. For example, the CAPTAIN'S PAK ONE-HAND-CRANK MANUAL SIDERIGGER brand reel from Big Jon Sports, Inc. of Interlochen Mich. allows the retrieval of a cannonball for downrigger fishing by clockwise rotation of its hand crank. The clockwise rotation of its hand crank automatically tightens the drag so that the rotational motion of the hand crank is transferred to the reel through the drag. The cannonball is attached to wire rope which is wound-up on the reel. If the hand crank is released, counter-clockwise rotation of the reel is prevented by the clutch bearing. If the hand crank is rotated in the counter-clockwise direction, the drag is progressively released allowing controlled decent of the cannonball. When the cannonball reaches the desired depth, the hand crank is rotated in the clockwise direction to increase the drag and stop the decent of the cannonball. Surprisingly, anchors have not been raised or lowered using a cranked anchor line reel employing a clutch bearing and a drag, which drag is controllably released by reverse rotation of the crank.

### SUMMARY OF THE INVENTION

The instant invention is a new use for a cranked reel employing a clutch bearing and a drag, which drag is controllably released by reverse rotation of the crank. The new use is to raise or lower an anchor using a cranked anchor line reel employing a clutch bearing and a drag, which drag is controllably released by reverse rotation of the crank. More specifically, the instant invention is a new use for apparatus comprising a reel, a shaft, a crank, a clutch bearing, and a drag washer, the reel mounted on a first portion of the shaft, a second portion of the shaft mounted in the clutch bearing so that the shaft will rotate only in one rotational direction, the crank threadably attached to a threaded third portion of the shaft so that when the crank is rotated in the rotational direction permitted by the clutch bearing, the crank threads onto the threaded portion of the shaft thereby compressing a drag washer mounted on the shaft directly or indirectly in contact with the reel and the shaft so that the reel rotates in the rotational direction permitted by the clutch bearing and so that when the crank is rotated in the rotational direction opposite the direction permitted by the clutch bearing, the crank unthreads from the threaded portion of the shaft thereby decompressing the drag washer mounted on the shaft directly or indirectly in contact with the reel and the shaft so that the reel can rotate in the rotational direction opposite that permitted by the clutch bearing, the new use being the raising or lowering of a boat anchor by attaching the boat anchor to one end of an anchor line and winding the other end of the anchor line on the reel.

### BRIEF DESCRIPTION OF THE DRAWINGS

FIG. 1 is a side view of a preferred apparatus for use in the instant invention having a hand cranked reel upon which an anchor line can be wound;

FIG. 2 is a front view of the apparatus shown in FIG. 1;

FIG. 3 is a back view of the apparatus shown in FIG. 1; and

FIG. 4 is an enlarged cross-sectional side view of a portion of the apparatus shown in FIG. 1.

### DETAILED DESCRIPTION

The instant invention is a new use for apparatus comprising a reel, a shaft, a crank, a clutch bearing, and a drag washer, the reel mounted on a first portion of the shaft, a second portion of the shaft mounted in the clutch bearing so that the shaft will rotate only in one rotational direction, the crank threadably attached to a threaded third portion of the shaft so that when the crank is rotated in the rotational direction permitted by the clutch bearing, the crank threads onto the threaded portion of the shaft thereby compressing a drag washer mounted on the shaft directly or indirectly in contact with the reel and the shaft so that the reel rotates in the rotational direction permitted by the clutch bearing and so that when the crank is rotated in the rotational direction opposite the direction permitted by the clutch bearing, the crank unthreads from the threaded portion of the shaft thereby decompressing the drag washer mounted on the shaft directly or indirectly in contact with the reel and the shaft so that the reel can rotate in the rotational direction opposite that permitted by the clutch bearing, the new use being the raising or lowering of a boat anchor by attaching the boat anchor to one end of an anchor line and winding the other end of the anchor line on the reel.

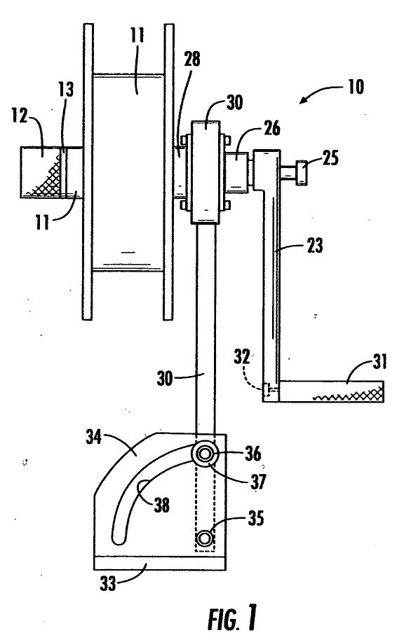

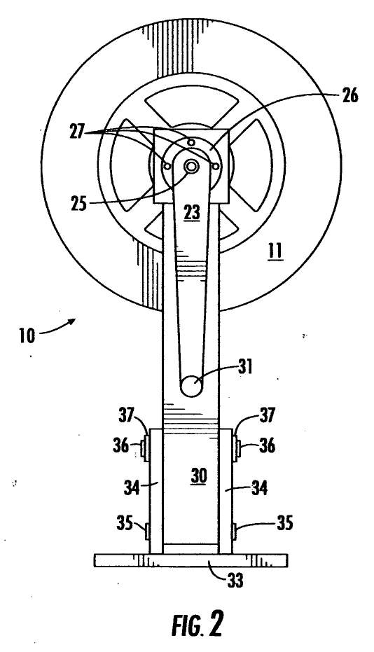

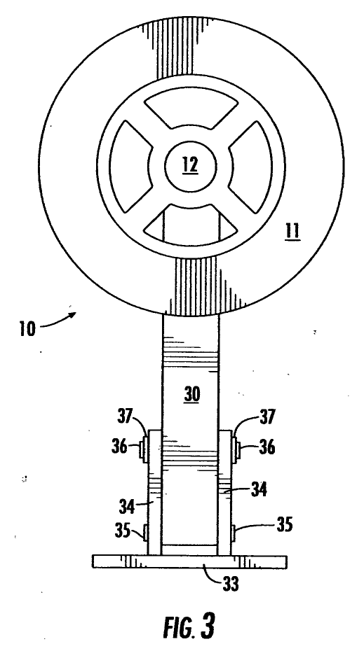

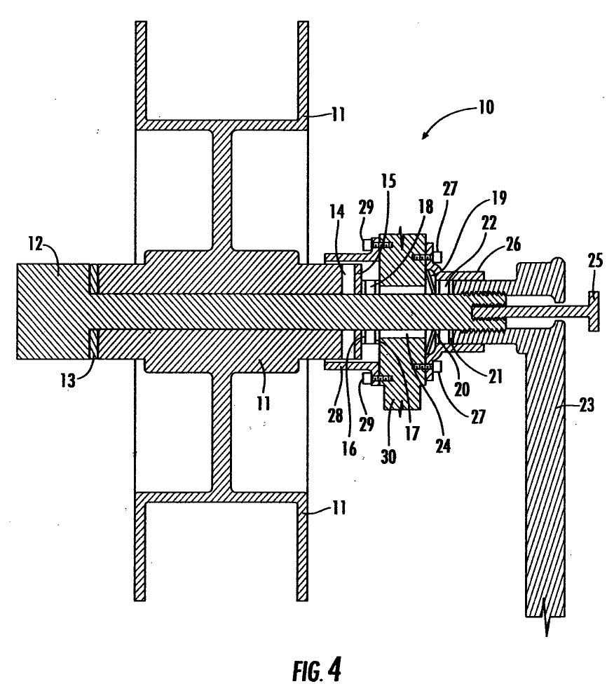

Referring now to FIG. 1, therein is shown a side view of a preferred apparatus 10 for use in the instant invention having a hand cranked reel 11 upon which an anchor line can be wound. FIG. 2 is a front view of the apparatus 10 shown in FIG. 1. FIG. 3 is a back view of the apparatus 10 shown in FIG. 1. FIG. 4 is an enlarged cross-sectional side view of a portion of the apparatus 10 shown in FIG. 1.

Referring now to FIG. 4, apparatus 10 comprises reel 11, shaft 12, hand crank 23, clutch bearing 27, and drag washers 13 and 14. Clutch bearings are also known as one way bearings or one way clutch bearings. The reel 11 is mounted on a central portion of the shaft 12. Another central portion of the shaft 12 is mounted in the clutch bearing 27 so that the shaft will rotate only in one rotational direction. The hand crank 23 is threadably attached to a threaded third portion of the shaft 12 so that when the hand crank 23 is rotated in the rotational direction permitted by the clutch bearing 27, the hand crank 23 threads onto the threaded portion of the shaft 12 thereby compressing the drag washers 13 and 14 mounted on the shaft directly or indirectly in contact with the reel 11 and the shaft 12 so that the reel 11 rotates in the rotational direction permitted by the clutch bearing 27 and so that when the hand crank 23 is rotated in the rotational direction opposite the direction permitted by the clutch bearing 27, the hand crank 23 unthreads from the threaded portion of the shaft 12 thereby decompressing the drag washers 13 and 14 mounted on the shaft directly or indirectly in contact with the reel 11 and the shaft 12 so that the reel 11 can rotate in the rotational direction opposite that permitted by the clutch bearing 27 thereby facilitating the raising or lowering of a boat anchor by attaching the boat anchor to one end of an anchor line and winding the other end of the anchor line on the reel 11.

Referring still to FIG. 4, other details of the apparatus 10 will be described. Steel washers 15, 16, 17, 20 and 21 are mounted on shaft 12 as shown. A Belleville washer 19 is mounted on shaft 12 as shown. When the crank 23 is rotated in the direction permitted by the clutch bearing 27, the crank 23 presses against the thrust bearing assembly 21, 22, 20, compressing Belleville washer 19, pulling the other end of shaft 12 to compress drag washer 13, drag washer 14, washer 18 and thrust bearing assembly 16, 18 and 17. Thrust bearing 27 is mounted in stanchion 30. An outer sleeve 26 is attached to stanchion 30 by cap screws 27. An inner sleeve 28 is attached to stanchion 30 by cap screws 29. Retaining bolt 25 prevents inadvertent separation of the crank 23 from the shaft 12.

Referring again to FIG. 1, one end of the stanchion 30 is attached to base side 43 by pivot bolt 35. The base side 34 is attached to base bottom 33. The base bottom 33 is configured to be attached to a boat hull. Stanchion 30 can be pivoted to a stowed position by loosening stanchion locking bolt 36 and pivoting the locking bolt 36 in the curved slot 38 in base side 34. Stanchion locking bolt washer 37 is positioned as shown. A crank handle 31 is mounted to one end of crank 23 by crank handle retaining screw 32.

Referring still to FIG. 1, most preferably, the reel 11 is made of cast aluminum, has an outer diameter of about twelve inches, an drum diameter of about seven and one half inches and a width of about three and one half inches. Such a reel can hold over 300 feet of one quarter inch diameter anchor rope. The drag washers are preferably fiber washers. Preferably the remainder of the apparatus 10 is preferably made of steel, stainless steel or aluminum. It should be understood that the combination of a ratchet and a journal bearing is equivalent to a clutch bearing in the instant invention. It should be understood that the term “clutch bearing” in the claim of this application is intended to encompass the combination of a ratchet and a journal bearing. It should be understood that a cone drag as used in better quality fly fishing reels is equivalent to the “drag washer” drag in the instant invention. It should be understood that the term “drag washer” in the claim of this application is intended to encompass the use of such a cone drag. The crank of the instant invention can be a hand crank or a motor driven crank. A preferred motor driven crank comprises a gear motor employing a reversible direct current electric motor. Any suitable anchor line can be used in this invention, including rope made of natural or synthetic fibers and rope or chain made of a metal or a metal alloy. Most preferably, the anchor line is made of a synthetic fiber such as NYLON brand polyester fiber from DuPont.

In use (assuming the anchor is suspended above the water over the side of a boat via its anchor line wound on the reel 11) the crank 23 is rotated counterclockwise to let out the anchor to the bottom of, for example, a lake or a river. When the desired amount of anchor line has been let out the crank 23 is rotated clockwise to lock the rotation of the reel 11. If the boat is in a lake, an extra amount of line can be let out to permit the boat to drift downwind over a desired fishing location and then the crank 23 can be rotated to stop rotation of the reel 11 and maintain the position of the boat over the desired fishing location. If the boat is in a river, an extra amount of line can be let out to permit the boat to drift downriver over a desired fishing location and then the crank 23 can be rotated to stop rotation of the reel 11 and maintain the position of the boat over the desired fishing location. The position of the boat can then easily be further adjusted nearer or farther from the anchor by taking in or letting out the anchor line using the disclosed invention.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

What is claimed is:

1. A new use for apparatus comprising a reel, a shaft, a crank, a clutch bearing, and a drag washer, the reel mounted on a first portion of the shaft, a second portion of the shaft mounted in the clutch bearing so that the shaft will rotate only in one rotational direction, the crank threadably attached to a threaded third portion of the shaft so that when the crank is rotated in the rotational direction permitted by the clutch bearing, the crank threads onto the threaded portion of the shaft thereby compressing a drag washer mounted on the shaft directly or indirectly in contact with the reel and the shaft so that the reel rotates in the rotational direction permitted by the clutch bearing and so that when the crank is rotated in the rotational direction opposite the direction permitted by the clutch bearing, the crank unthreads from the threaded portion of the shaft thereby decompressing the drag washer mounted on the shaft directly or indirectly in contact with the reel and the shaft so that the reel can rotate in the rotational direction opposite that permitted by the clutch bearing, the new use being the raising or lowering of a boat anchor by attaching the boat anchor to one end of an anchor line and winding the other end of the anchor line on the reel.
